(19) United States
(12) Patent Application Publication
(10) Pub. No.: US 2020/0306998 A1
(43) Pub. Date: Oct. 1, 2020

(54) Multi-Body Controller

(71) Applicant: Boston Dynamics, Inc., Waltham, MA (US)

(72) Inventors: Shervin Talebi, Waltham, MA (US); Alex Perkins, Arlington, MA (US); Kevin Blankespoor, Arlington, MA (US)

(73) Assignee: Boston Dynamics, Inc., Waltham, MA (US)

(21) Appl. No.: 16/363,326

(22) Filed: Mar. 25, 2019

(51) Int. Cl. B25J 19/00; B25J 9/16

(52) U.S. Cl. CPC B25J 19/002; B25J 9/1638; B25J 15/0616; B25J 9/1666; B25J 9/1661

(57) ABSTRACT

A method for a multi-body controller receives steering commands for a robot to perform a given task. The robot includes an inverted pendulum body, a plurality of joints, an arm coupled to the inverted pendulum body, a leg coupled to the inverted pendulum body, and a drive wheel rotatably coupled to the leg. With the steering commands, the method generates a wheel torque and a wheel axle force to perform the given task. The method includes receiving movement constraints for the robot and manipulation inputs configured to manipulate the arm to perform the given task. For each joint, the method generates a corresponding joint torque having an angular momentum where the joint torque satisfies the movement constraints based on the manipulation inputs, the wheel torque, and the wheel axle force. The method further includes controlling the robot to perform the given task using the joint torques.

### TECHNICAL FIELD

This disclosure relates to a multi-body controller for a robot.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction based mechanisms), or some combination of a manipulator and a mobile robot. Robots are utilized in a variety of industries including, for example, manufacturing, transportation, hazardous environments, exploration, and healthcare. As such, the ability to balance the robot while performing tasks in an environment may enhance a robots functionality and provide additional benefits to these industries.

### SUMMARY

One aspect of the disclosure provides a method for a multi-body controller. The method includes receiving, at data processing hardware of a robot, steering commands to perform a given task within an environment about the robot. The robot includes an inverted pendulum body having a first end portion, a second end portion, and a plurality of joints and an arm coupled to the inverted pendulum body at a first joint of the plurality of joints where the arm includes an end-effector configured to grasp an object. The robot also includes at least one leg having first and second ends, the first end coupled to the inverted pendulum body at a second joint of the plurality of joints, and a drive wheel rotatably coupled to the second end of the at least one leg. The method further includes, based on the received steering commands, generating, by the data processing hardware, a wheel torque for the drive wheel of the robot and a wheel axle force at the drive wheel of the robot. The wheel torque and the wheel axle force are generated to perform the given task. The method also includes receiving, at the data processing hardware, movement constraints indicating movement limitations for the robot and receiving, at the data processing hardware, manipulation inputs for the arm of the robot. The manipulation inputs are configured to manipulate the arm of the robot to perform the given task. For each joint of the plurality of joints, the method further includes generating, by the data processing hardware, a corresponding joint torque configured to control the robot to perform the given task, the joint torque satisfying the movement constraints based on the manipulation inputs, the wheel torque, and the wheel axle force. The method also includes controlling, by the data processing hardware, the robot to perform the given task using the joint torques generated for the plurality of joints.

Implementations of the disclosure may include one or more of the following optional features. In some implementations, generating the corresponding joint torque for each of the plurality of joints includes using a joint torque algorithm to achieve a balance objective to balance the robot and to achieve a manipulation objective to move the arm of the robot based on the given task where the joint torque algorithm includes a quadratic function based on the received movement constraints. When the balance objective or the manipulation objective is indeterminate while using the joint torque algorithm to achieve the balance objective and to achieve the manipulation objective, the joint torque algorithm may apply a default torque to determine the balance objective and the manipulation objective. Using the joint torque algorithm to achieve the balance objective and to achieve the manipulation objective may include applying a first weight to the balance objective and applying a second weight to the manipulation objective, the first weight and the second weight indicating a torque importance for the given task.

In some examples, the movement constraints include at least one of range of motion limitations for each of the plurality of joints, torque limitations for each of the plurality of joints, or collision limitations configured to avoid collisions for a portion of the robot. The first end of the at least one leg may be prismatically coupled to the first end portion of the inverted pendulum body.

In some configurations, the robot includes a counter-balance body disposed on the inverted pendulum body and is configured to move relative to the inverted pendulum body. The counter-balance body may be disposed on the first end portion of the inverted pendulum body. Additionally or alternatively, the counter-balance body may be disposed on the second end portion of the inverted pendulum body. The plurality of joints of the inverted pendulum body may include the first joint coupling the arm to the inverted pendulum body, the second joint coupling the at least one leg to the inverted pendulum body, a third joint coupling the inverted pendulum body to the counter-balance body, and at least one arm joint coupling two members of the arm together. The arm may include a first member having a first end and a second end, the first end of the first member coupled to the first end portion of the inverted pendulum body at the first joint, a second member having a first end and a second end, the first end of the second member coupled to the second end of the first member at a first arm joint of the at least one arm joint, and a third member having a first end and a second end, the first end of the third member coupled to the second end of the second member at a second arm joint of the at least one arm joint. The at least one leg may include a right leg having first and second ends and a left leg having first and second ends. Here, the first end of the right leg is prismatically coupled to the second end portion of the inverted pendulum body, the right leg having a right drive wheel rotatably coupled to the second end of the right leg and the first end of the left leg is prismatically coupled to the second end portion of the inverted pendulum body, the left leg having a left drive wheel rotatably coupled to the second end of the left leg.

In some implementations, the manipulation inputs correspond to a force or an acceleration for the end-effector. In some examples, controlling the robot to perform the given task using the joint torques generated for the plurality of joints includes generating a manipulation force based on the joint torques generated for the plurality of joints and applying the manipulation force at the end-effector of the robot.

Another aspect of the disclosure provides a robot. The robot includes an inverted pendulum body having a first end portion, a second end portion, and a plurality of joints. The robot also includes an arm coupled to the inverted pendulum body at a first joint of the plurality of joints and at least one leg having first and second ends, the first end coupled to the inverted pendulum body at a second joint of the plurality of joints. The robot further includes a drive wheel rotatably coupled to the second end of the at least one leg and data processing hardware. The robot further includes memory hardware in communication with the data processing hardware, the memory hardware storing instructions that when executed on the data processing hardware cause the data processing hardware to perform operations. The operations include receiving steering commands to perform a given task within an environment about the robot. Based on the received steering commands, the operations include generating a wheel torque for the drive wheel of the robot and a wheel axle force at the drive wheel of the robot, the wheel torque and the wheel axle force generated to perform the given task. The operations also include, receiving movement constraints indicating movement limitations for the robot and receiving manipulation inputs for the arm of the robot, the manipulation inputs configured to manipulate the arm of the robot to perform the given task. For each joint of the plurality of joints, the operations include generating a corresponding joint torque configured to control the robot to perform the given task, the joint torque satisfying the movement constraints based on the manipulation inputs, the wheel torque, and the wheel axle force. The operations further include controlling the robot to perform the given task using the joint torques generated for the plurality of joints.

This aspect may include one or more of the following optional features. In some configurations, generating the corresponding joint torque for each of the plurality of joints includes using a joint torque algorithm to achieve a balance objective to balance the robot and to achieve a manipulation objective to move the arm of the robot based on the given task, the joint torque algorithm including a quadratic function based on the received movement constraints. When the balance objective or the manipulation objective is indeterminate while using the joint torque algorithm to achieve the balance objective and to achieve the manipulation objective, the joint torque algorithm may apply a default torque to determine the balance objective and the manipulation objective. Using the joint torque algorithm to achieve the balance objective and to achieve the manipulation objective may include applying a first weight to the balance objective and applying a second weight to the manipulation objective, the first weight and the second weight indicating a torque importance for the given task.

In some examples, the movement constraints include at least one of range of motion limitations for each of the plurality of joints, torque limitations for each of the plurality of joints, or collision limitations configured to avoid collisions for a portion of the robot. The first end of the at least one leg may be prismatically coupled to the first end portion of the inverted pendulum body.

In some implementations, the robot includes a counter-balance body disposed on the inverted pendulum body and configured to move relative to the inverted pendulum body. The counter-balance body may be disposed on the first end portion of the inverted pendulum body or on the second end portion of the inverted pendulum body. The plurality of joints of the inverted pendulum body may include the first joint coupling the arm to the inverted pendulum body, the second joint coupling the at least one leg to the inverted pendulum body, a third joint coupling the inverted pendulum body to the counter-balance body, and at least one arm joint coupling two members of the arm together. The arm may include a first member having a first end and a second end, the first end of the first member coupled to the first end portion of the inverted pendulum body at the first joint, a second member having a first end and a second end, the first end of the second member coupled to the second end of the first member at a first arm joint of the at least one arm joint, and a third member having a first end and a second end, the first end of the third member coupled to the second end of the second member at a second arm joint of the at least one arm joint. The at least one leg may include a right leg having first and second ends, the first end of the right leg prismatically coupled to the second end portion of the inverted pendulum body, the right leg having a right drive wheel rotatably coupled to the second end of the right leg. The at least one leg may also include a left leg having first and second ends, the first end of the left leg prismatically coupled to the second end portion of the inverted pendulum body, the left leg having a left drive wheel rotatably coupled to the second end of the left leg.

In some examples, the manipulation inputs correspond to a force or an acceleration for the end-effector. In some configurations, controlling the robot to perform the given task using the joint torques generated for the plurality of joints includes generating a manipulation force based on the joint torques generated for the plurality of joints and applying the manipulation force at the end-effector of the robot.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of an example of a robot lifting a box within an environment.

FIG. 1B is a perspective view of an example of the robot.

FIG. 1C is a schematic view of an example arrangement of system of a robot of FIG. 1B.

FIGS. 2A-2C are schematic views of example multi-body controllers for the robot of FIG. 1B.

FIG. 3 is an example arrangement of operations for a robot to implement the multi-body controller for the robot of FIG. 1B.

FIG. 4 is a schematic view of an example computing device that may be used to implement the systems and methods described herein.

Like reference symbols in the various drawings indicate like elements.

### DETAILED DESCRIPTION

Mobile robots are robots that may move about an environment. Some more common examples of robot mobility include an ambulatory motion (e.g., with legs in a gait pattern) or a rolling motion (e.g., with one or more wheels). When the mobile robot moves according to a rolling motion, one or more wheels (referred to generally as wheels) of the mobile robot engage with a surface (e.g., a ground surface) to generate traction to move the robot in a desired direction across the surface. Besides physically moving the robot, wheels of a mobile robot may generate motion (i.e., by traction) to maintain balance for the robot. As the mobile robot moves about the environment, the mobile robot may perform tasks. Generally, these tasks include interacting with objects and/or the elements of the environment. For example, the mobile robot may detect objects or manipulate objects (e.g., move/transport) within the environment. An issue that commonly arises as the mobile robot performs these tasks is that the tasks may impact the mobile robot's balance. In other words, when performing tasks, parts of the mobile robot, such as components of the robot's body and/or manipulators associated with mobile robot (e.g., appendages of the robot), may change the mobile robot's center of mass (COM) resulting in an unbalanced state for the mobile robot. In order to balance when this change to COM occurs, a mobile robot may roll one or more wheels to a position that redistributes the COM such that the mobile robot is in a balanced position.

One of the problems with this wheel balancing approach is that at least one of the wheels may be often rolling back and forth. This is increasingly true when the mobile robot has to perform tasks requiring manipulation of an object (e.g., picking up or putting down an object). Here, when the mobile robot lifts the object with a manipulator (e.g., a robotic arm), a weight of the object at a distance from the mobile robot's COM generates a moment (i.e., torque). The mobile robot may counteract this moment caused by the mobile robot engaging with the object by generating a counter moment. In some examples, the wheels generate a traction force as the counter moment. Stated differently, engaging the object changes the distribution of mass for the mobile robot resulting in a shift of the COM for the robot when compared to the robot disengaged from the object. In order to maintain balance due to this shift in the COM, the wheels may move to a position that aligns the wheels with the shifted COM.

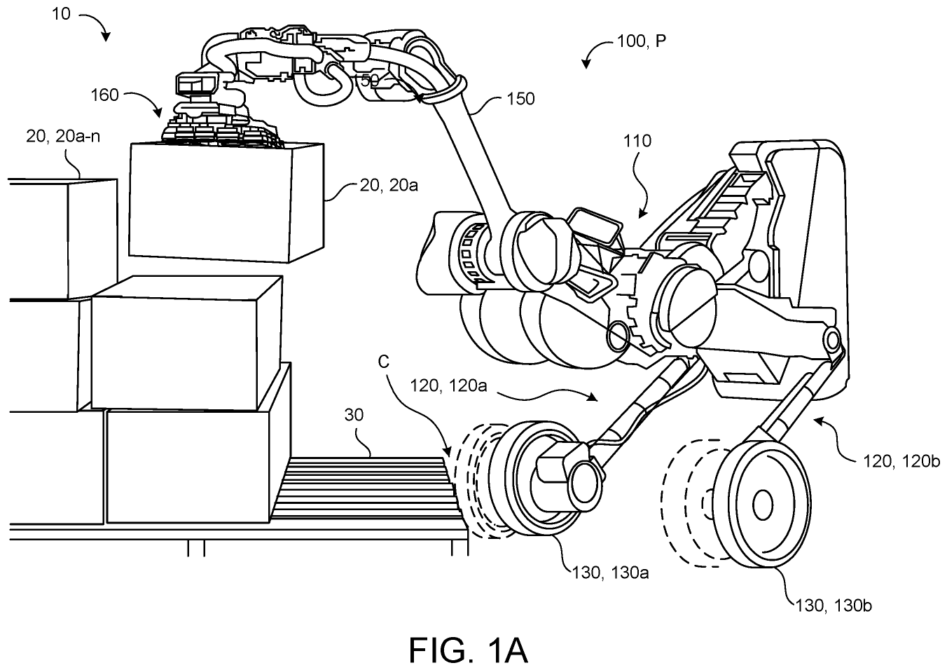

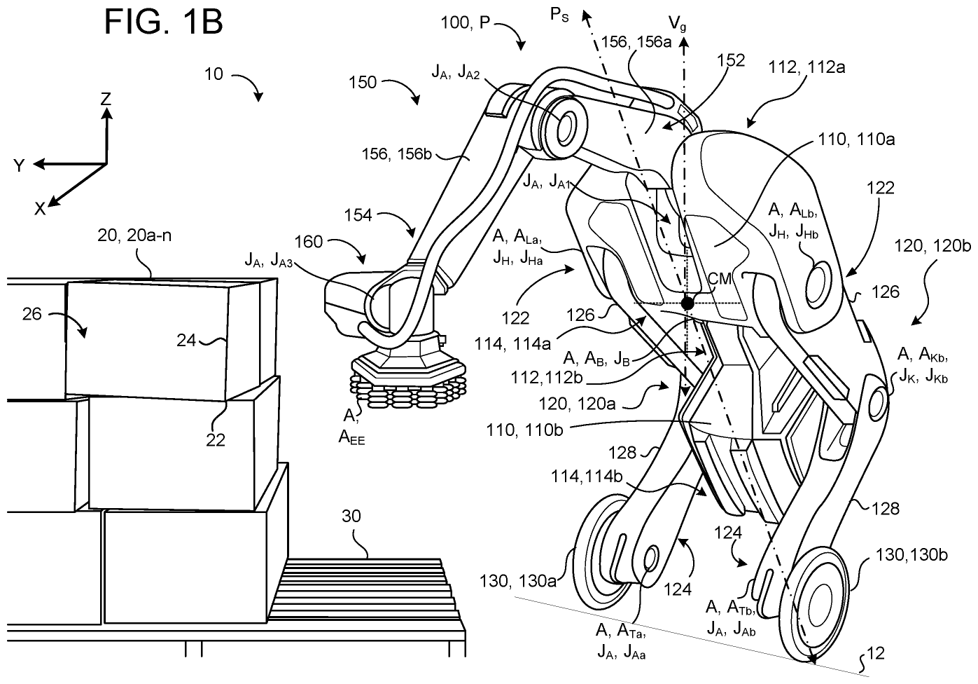

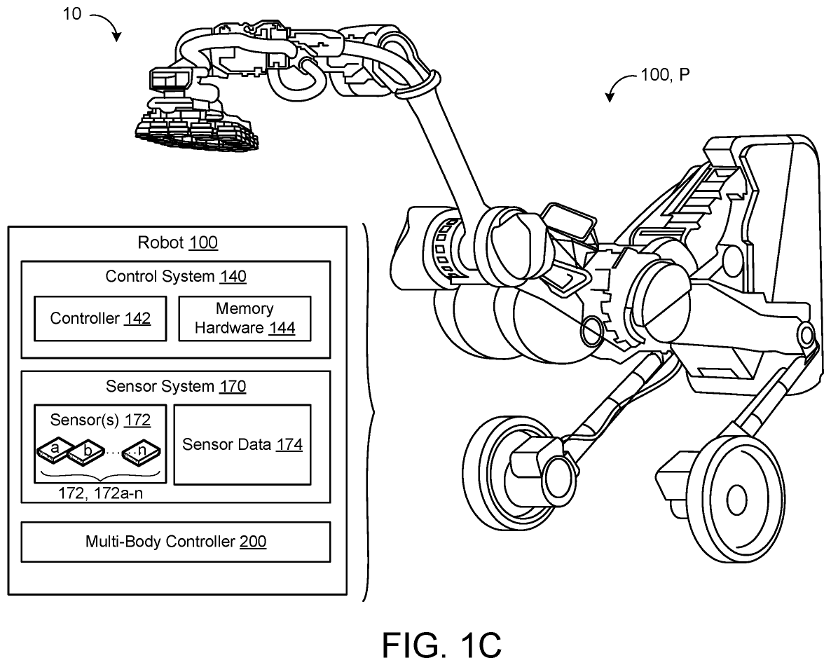

Unfortunately, mobile robots may have constraints during operation. For instance, the mobile robot is spatially constrained (e.g., ground obstacles exist around the robot). One such example of a spatial constraint is a situation where the mobile robot encounters a ground obstacle. For example, when the mobile robot is lifting a box off a pallet, the pallet, as a ground obstacle, introduces a spatial constraint that may limit travel of the wheels of the mobile robot. When the mobile robot lifts the box off the pallet, a mobile robot using the wheel balancing approach risks driving the wheels into the pallet to balance the mobile robot (e.g., as down in FIG. 1A by the dotted wheels). Here, a collision between the pallet and the wheels may compromise the task of lifting the box. On one hand, the pallet may prevent the wheels from moving to a position that completely balances the mobile robot causing the mobile robot to lose its balance and fall (e.g., risking damage to the box and/or robot). On the other hand, the pallet may be light enough that the wheels are able to move the pallet to a position that allows the wheels to balance the mobile robot. Here, the movement of the pallet may cause other boxes on the pallet to shift and/or to fall (e.g., also potentially damaging the boxes). Accordingly, the wheel balancing approach is not always an effective way to balance the mobile robot due to collision risks with ground obstacles.

For a more effective approach in situations where the mobile robot risks collisions with ground obstacles, the mobile robot may employ coordinated joint torque control. Coordinated joint torque control refers to a control method for balancing the robot that takes advantage of angular momentum resulting from movement of one or more joints. By relying on one or more joints of the robot for balance, the wheels of the mobile robot do not need to be the only system balancing the robot. This reduces wheel movement during manipulation tasks; therefore, minimizing or eliminating the mobile robot's risk of collisions with ground obstacles.

In order to employ the coordinated joint torque control method for balance, the robot is configured to account for and to control the multi-body structure of the robot. Here, the term multi-body (i.e., corresponding to “multi-body” controller) refers to inertial bodies of the mobile robot. An inertial body is not just a body or a torso of a mobile robot, but rather a component (e.g., arms, legs, body (torso), head, tail, etc.) of the robot with mass attributing to the COM of the robot. This means that the mobile robot may include a single body that corresponds to its torso, but still use a multi-body controller because the multi-body controller controls the legs and/or arms in addition to the single body. Coordinated joint torque control functions by controlling torque at one or more joints that couple together components (i.e., inertial bodies) of the robot (e.g., by means of an actuator at or adjacent to a joint).

FIG. 1A depicts an example of the wheel balancing approach compared to a coordinate joint torque control method for balance. In this example, the robot 100 generally includes a body 110, at least one leg 120 (e.g., shown as two legs 120, 120a-b), drive wheels 130 coupled to each leg 120, and an arm 150 with an end-effector 160. The robot 100 is within an environment 10 that includes a plurality of boxes 20, 20a-n stacked on a pallet 30. Here, using the end-effector 160, the mobile robot 100 is lifting a box 20a from a pallet 30 that poses a collision risk for the robot 100. When the robot 100 uses the wheel balancing approach, one or more drive wheels 130 of the robot 100, as shown in dotted lines, will inevitably cause a collision C with the pallet 30. In contrast, by employing the joint coordinated approach, the joints J of the robot 100 contribute an angular momentum effect that makes the robot 100 less reliant on wheel balancing. In other words, with the joint coordinate approach, the drove wheels 130 may remain stationary as illustrated by the solid black outlined drive wheels 130.

FIG. 1B is an example of a mobile robot 100 (also referred to as a robot) operating within the environment 10 that includes at least one box 20. Here, the environment 10 includes a plurality of boxes 20, 20a-n stacked on a pallet 30 lying on a ground surface 12. The robot 100 may move (e.g., drive) across the ground surface 12 to detect and/or to manipulate boxes 20 within the environment 10. For example, the pallet 30 may correspond to a delivery truck that the robot 100 loads or unloads. Here, the robot 100 may be a logistics robot associated with a shipping and/or receiving stage of logistics. As a logistics robot, the robot 100 may palletize or detect boxes 20 for logistics fulfillment or inventory management. For instance, the robot 100 detects a box 20, processes the box 20 for incoming or outgoing inventory, and moves the box 20 about the environment 10.

The robot 100 has a vertical gravitational axis V_{g} along a direction of gravity, and a center of mass COM, which is a point where the robot 100 has a zero sum distribution of mass. The robot 100 further has a pose P based on the COM relative to the vertical gravitational axis V_{g} to define a particular attitude or stance assumed by the robot 100. The attitude of the robot 100 can be defined by an orientation or an angular position of an object in space.

The robot 100 generally includes a body 110 and one or more legs 120. The body 110 of the robot 100 may be a unitary structure or a more complex design depending on the tasks to be performed in the environment 10. The body 110 may allow the robot 100 to balance, to sense about the environment 10, to power the robot 100, to assist with tasks within the environment 10, or to support other components of the robot 100. In some examples, the robot 100 includes a two-part body 110. For example, the robot 100 includes an inverted pendulum body (IPB) 110, 110a (i.e., referred to as a torso 110a of the robot 100) and a counter-balance body (CBB) 110, 110b (i.e., referred to as a tail 110b of the robot 100) disposed on the IPB 110a.

The body 110 (e.g., the IPB 110a or the CBB 110b) has first end portion 112 and a second end portion 114. For instance the IPB 110a has a first end portion 112a and a second end portion 114a while the CBB 110b has a first end portion 112b and a second end portion 114b. In some implementations, the CBB 110b is disposed on the second end portion 114a of the IPB 110a and configured to move relative to the IPB 110a. In some examples, the CBB 110b includes a battery that serves to power the robot 100. A back joint J, J_{B} may rotatably couple the CBB 110b to the second end portion 114a of the IPB 110a to allow the CBB 110b to rotate relative to the IPB 110a. The back joint J_{B} may be referred to as a pitch joint. In the example shown, the back joint J_{B} supports the CBB 110b to allow the CBB 110b to move/pitch around a lateral axis (y-axis) that extends perpendicular to the gravitational vertical axis V_{g} and a fore-aft axis (x-axis) of the robot 100. The fore-aft axis (x-axis) may denote a present direction of travel by the robot 100. Movement by the CBB 110b relative to the IPB 110a alters the pose P of the robot 100 by moving the COM of the robot 100 relative to the vertical gravitational axis V_{g}. A rotational actuator or back joint actuator A, A_{B} (e.g., a tail actuator or counter-balance body actuator) may be positioned at or near the back joint J_{B} for controlling movement by the CBB 110b (e.g., tail) about the lateral axis (y-axis). The rotational actuator A_{B} may include an electric motor, electro-hydraulic servo, piezo-electric actuator, solenoid actuator, pneumatic actuator, or other actuator technology suitable for accurately effecting movement of the CBB 110b relative to the IPB 110a.

The rotational movement by the CBB 110b relative to the IPB 110a alters the pose P of the robot 100 for balancing and maintaining the robot 100 in an upright position. For instance, similar to rotation by a flywheel in a conventional inverted pendulum flywheel, rotation by the CBB 110b relative to the gravitational vertical axis V_{g} generates/imparts the moment at the back joint J_{B} to alter the pose P of the robot 100. By moving the CBB 110b relative to the IPB 110a to alter the pose P of the robot 100, the COM of the robot 100 moves relative to the gravitational vertical axis Vg to balance and maintain the robot 100 in the upright position in scenarios when the robot 100 is moving and/or carrying a load. However, by contrast to the flywheel portion in the conventional inverted pendulum flywheel that has a mass centered at the moment point, the CBB 110b includes a corresponding mass that is offset from moment imparted at the back joint J_{B} some configurations, a gyroscope disposed at the back joint J_{B} could be used in lieu of the CBB 110b to spin and impart the moment (rotational force) for balancing and maintaining the robot 100 in the upright position.

The CBB 110b may rotate (e.g., pitch) about the back joint J_{B} in both the clockwise and counter-clockwise directions (e.g., about the y-axis in the “pitch direction”) to create an oscillating (e.g., wagging) movement. Movement by the CBB 110b relative to IPB 110a between positions causes the COM of the robot 100 to shift (e.g., lower toward the ground surface 12 or higher away from the ground surface 12). The CBB 110b may oscillate between movements to create the wagging movement. The rotational velocity of the CBB 110b when moving relative to the IPB 110a may be constant or changing (accelerating or decelerating) depending upon how quickly the pose P of the robot 100 needs to be altered for dynamically balancing the robot 100.

The legs 120 are locomotion-based structures (e.g., legs and/or wheels) that are configured to move the robot 100 about the environment 10. The robot 100 may have any number of legs 120 (e.g., a quadruped with four legs, a biped with two legs, a hexapod with six legs, an arachnid-like robot with eight legs, etc.). Here, for simplicity, the robot 100 is generally shown and described with two legs 120, 120a-b.

As a two-legged robot 100, the robot includes a first leg 120, 120a and a second leg 120, 120b. In some examples, each leg 120 includes a first end 122 and a second end 124. The second end 124 corresponds to an end of the leg 120 that contacts or is adjacent to a member of the robot 100 contacting a surface (e.g., a ground surface) such that the robot 100 may traverse the environment 10. For example, the second end 124 corresponds to a foot of the robot 100 that moves according to a gait pattern. In some implementations, the robot 100 moves according to rolling motion such that the robot 100 includes a drive wheel 130. The drive wheel 130 may be in addition to or instead of a foot-like member of the robot 100. For example, the robot 100 is capable of moving according to ambulatory motion and/or rolling motion. Here, the robot 100 depicted in FIG. 1B illustrates the first end 122 coupled to the body 110 (e.g., at the IPB 110a) while the second end 124 is coupled to the drive wheel 130. By coupling the drive wheel 130 to the second end 124 of the leg 120, the drive wheel 130 may rotate about an axis of the coupling to move the robot 100 about the environment 10.

Hip joints J, J_{H} on each side of body 110 (e.g., a first hip joint J_{H}, J_{Ha} and a second hip joint J_{H}, J_{Hb} symmetrical about a sagittal plane P_{S} of the robot 100) may rotatably couple the first end 122 of a leg 120 to the second end portion 114 of the body 110 to allow at least a portion of the leg 120 to move/pitch around the lateral axis (y-axis) relative to the body 110. For instance, the first end 122 of the leg 120 (e.g., of the first leg 120a or the second leg 120b) couples to the second end portion 114a of the IPB 110a at the hip joint J_{H} to allow at least a portion of the leg 120 to move/pitch around the lateral axis (y-axis) relative to the IPB 110a.

A leg actuator A, A_{L} may be associated with each hip joint J_{H} (e.g., a first leg actuator A_{L}, A_{La} and a second leg actuator A_{L}, A_{Lb}). The leg actuator A_{L} associated with the hip joint J_{H} may cause an upper portion 126 of the leg 120 (e.g., the first leg 120a or the second leg 120b) to move/pitch around the lateral axis (y-axis) relative to the body 110 (e.g., the IPB 110a). In some configurations, each leg 120 includes the corresponding upper portion 126 and a corresponding lower portion 128. The upper portion 126 may extend from the hip joint J_{H} at the first end 122 to a corresponding knee joint J, J_{K} and the lower portion 128 may extend from the knee joint J_{K} to the second end 124. A knee actuator A, A_{K} associated with the knee joint J_{K} may cause the lower portion 128 of the leg 120 to move/pitch about the lateral axis (y-axis) relative to the upper portion 126 of the leg 120.

Each leg 120 may include a corresponding ankle joint J, J_{A} configured to rotatably couple the drive wheel 130 to the second end 124 of the leg 120. For example, the first leg 120a includes a first ankle joint J_{A}, J_{Aa} and the second leg 120b includes a second ankle joint J_{A}, J_{Ab}. Here, the ankle joint J_{A} may be associated with a wheel axle coupled for common rotation with the drive wheel 130 and extending substantially parallel to the lateral axis (y-axis). The drive wheel 130 may include a corresponding torque actuator (drive motor) A, A_{T} configured to apply a corresponding axle torque for rotating the drive wheel 130 about the ankle joint J_{A} to move the drive wheel 130 across the ground surface 12 along the fore-aft axis (x-axis). For instance, the axle torque may cause the drive wheel 130 to rotate in a first direction for moving the robot 100 in a forward direction along the fore-aft axis (x-axis) and/or cause the drive wheel 130 to rotate in an opposite second direction for moving the robot 100 in a rearward direction along the fore-aft axis (x-axis).

In some implementations, the legs 120 are prismatically coupled to the body 110 (e.g., the IPB 110a) such that a length of each leg 120 may expand and retract via a corresponding actuator (e.g., leg actuators A_{L}) proximate the hip joint J_{H}, a pair of pulleys (not shown) disclosed proximate the hip joint J_{H} and the knee joint J_{K} and a timing belt (not shown) synchronizing rotation of the pulleys. Each leg actuator A_{L} may include a linear actuator or a rotational actuator. Here, a control system 140 with a controller 142 (e.g., shown in FIG. 1C) may actuate the actuator associated with each leg 120 to rotate the corresponding upper portion 126 relative to the body 110 (e.g., the IPB 110a) in one of a clockwise direction or a counter-clockwise direction to prismatically extend/expand the length of the leg 120 by causing the corresponding lower portion 128 to rotate about the corresponding knee joint J_{K} relative to the upper portion 126 in the other one of the clockwise direction or the counter-clockwise direction. Optionally, instead of a two-link leg, the at least one leg 120 may include a single link that prismatically extends/retracts linearly such that the second end 124 of the leg 120 prismatically moves away/toward the body 110 (e.g., the IPB 110a) along a linear rail. In other configurations, the knee joint J_{K} may employ a corresponding a rotational actuator as the knee actuator A_{K} for rotating the lower portion 128 relative to the upper portion 126 in lieu of a pair of synchronized pulleys.

The corresponding axle torques applied to each of the drive wheels 130 (e.g., a first drive wheel 130, 130a associated with the first leg 120a and a second drive wheel 130, 130b associated with the second leg 120b) may vary to maneuver the robot 100 across the ground surface 12. For instance, an axle torque (i.e., a wheel torque τ_{W}) applied to the first drive wheel 130a that is greater than a wheel torque τ_{W} applied to the second drive wheel 130b may cause the robot 100 to turn to the left, while applying a greater wheel torque τ_{W} to the second drive wheel 130b than to the first drive wheel 130 may cause the robot 100 to turn to the right. Similarly, applying substantially the same magnitude of wheel torque τ_{W} to each of the drive wheels 130 may cause the robot 100 to move substantially straight across the ground surface 12 in either the forward or reverse directions. The magnitude of axle torque T_{A} applied to each of the drive wheels 130 also controls velocity of the robot 100 along the fore-aft axis (x-axis). Optionally, the drive wheels 130 may rotate in opposite directions to allow the robot 100 to change orientation by swiveling on the ground surface 12. Thus, each wheel torque τ_{W} may be applied to the corresponding drive wheel 130 independent of the axle torque (if any) applied to the other drive wheel 130.

In some examples, the body 110 (e.g., at the CBB 110b) also includes at least one non-drive wheel (not shown). The non-drive wheel is generally passive (e.g., a passive caster wheel) and does not contact the ground surface 12 unless the body 110 moves to a pose P where the body 110 (e.g., the CBB 110b) is supported by the ground surface 12.

In some implementations, the robot 100 further includes one or more appendages, such as an articulated arm 150 (also referred to as an arm or a manipulator arm) disposed on the body 110 (e.g., on the IPB 110a) and configured to move relative to the body 110. The articulated arm 150 may have one or more degrees of freedom (e.g., ranging from relatively fixed to capable of performing a wide array of tasks in the environment 10). Here, the articulated arm 150 illustrated in FIG. 1B has five-degrees of freedom. While FIG. 1B shows the articulated arm 150 disposed on the first end portion 112 of the body 110 (e.g., at the IPB 110a), the articulated arm 150 may be disposed on any part of the body 110 in other configurations. For instance, the articulated arm 150 is disposed on the CBB 110b or on the second end portion 114a of the IPB 110a.

The articulated arm 150 extends between a proximal first end 152 and a distal second end 154. The arm 150 may include one or more arm joints J, J_{A} between the first end 152 and the second end 154 where each arm joint J_{A} is configured to enable the arm 150 to articulate in the environment 10. These arm joints J_{A} may either couple an arm member 156 of the arm 150 to the body 110 or couple two or more arm members 156 together. For example, the first end 152 connects to the body 110 (e.g., the IPB 110a) at a first articulated arm joint J, J_{A1} (e.g., resembling a shoulder joint). In some configurations, the first articulated arm joint J_{A1} is disposed between the hip joints J_{H} (e.g., aligned along the sagittal plane P_{S} of the robot 100 at the center of the body 110). In some examples, the first articulated arm joint J_{A1} rotatably couples the proximal first end 152 of the arm 150 to the body 110 (e.g., the IPB 110a) to enable the arm 150 to rotate relative to the body 110 (e.g., the IPB 110a). For instance, the arm 150 may move/pitch about the lateral axis (y-axis) relative to the body 110.

In some implementations, such as FIG. 1B, the arm 150 includes a second arm joint J, J_{A2} (e.g., resembling an elbow joint) and a third arm joint J, J_{A3} (e.g., resembling a wrist joint). The second arm joint J_{A2} couples a first arm member 156a to a second arm member 156b such that these members 156a-b are rotatable relative to one another and also to the body 110 (e.g., the IPB 110). Depending on a length of the arm 150, the second end 154 of the arm 150 coincides with an end of an arm member 156. For instance, although the arm 150 may have any number of arm members 156, FIG. 1B depicts the arm 150 with two arm members 156a-b such that the end of the second arm member 156b coincides with the second end 154 of the arm 150. Here, at the second end 154 of the arm 150, the arm 150 includes an end-effector 160 that is configured to perform tasks within the environment 10. The end-effector 160 may be disposed on the second end 154 of the arm 150 at an arm joint J_{A} (e.g., at the third arm joint J_{A3}) to allow the end-effector 160 to have multiple degrees of freedom during operation. The end-effector 160 may include one or more end-effector actuators A, A_{EE} for gripping/grasping objects. For instance, the end-effector 160 includes one or more suction cups as end-effector actuators A_{EE} to grasp or to grip objects by providing a vacuum seal between the end-effector 160 and a target object.

The articulated arm 150 may move/pitch about the lateral axis (y-axis) relative to the body 110 (e.g., the IPB 110a). For instance, the articulated arm 150 may rotate about the lateral axis (y-axis) relative to the body 110 in the direction of gravity to lower the COM of the robot 100 while executing turning maneuvers. The CBB 110b may also simultaneously rotate about the lateral axis (y-axis) relative to the IPB 110 in the direction of gravity to assist in lowering the COM of the robot 100. Here, the articulated arm 150 and the CBB 110b may cancel out any shifting in the COM of the robot 100 in the forward or rearward direction along the fore-aft axis (x-axis), while still effectuating the COM of the robot 100 to shift downward closer to the ground surface 12.

With reference to FIG. 1C, the robot 100 includes a control system 140 configured to monitor and to control operation of the robot 100. In some implementations, the robot 100 is configured to operate autonomously and/or semi-autonomously. However, a user may also operate the robot by providing commands/directions to the robot 100. In the example shown, the control system 140 includes a controller 142 (e.g., data processing hardware) and memory hardware 144. The controller 142 may include its own memory hardware or utilize the memory hardware 144 of the control system 140. In some examples, the control system 140 (e.g., with the controller 142) is configured to communicate (e.g., command motion) with the actuators A (e.g., back actuator(s) A_{B}, leg actuator(s) A_{L}, knee actuator(s) A_{K}, drive belt actuator(s), rotational actuator(s), end-effector actuator(s) A_{EE}, etc.) to enable the robot 100 to move about the environment 10. The control system 140 is not limited to the components shown, and may include additional (e.g., a power source) or less components without departing from the scope of the present disclosure. The components may communicate by wireless or wired connections and may be distributed across multiple locations of the robot 100. In some configurations, the control system 140 interfaces with a remote computing device and/or a user. For instance, the control system 140 may include various components for communicating with the robot 100, such as a joystick, buttons, transmitters/receivers, wired communication ports, and/or wireless communication ports for receiving inputs from the remote computing device and/or user, and providing feedback to the remote computing device and/or user.

The controller 142 corresponds to data processing hardware that may include one or more general purpose processors, digital signal processors, and/or application specific integrated circuits (ASICs). In some implementations, the controller 142 is a purpose-built embedded device configured to perform specific operations with one or more subsystems of the robot 100. Additionally or alternatively, the controller 142 includes a software application programmed to execute functions for systems for the robot 100 using the data processing hardware of the controller 142. The memory hardware 144 is in communication with the controller 142 and may include one or more non-transitory computer-readable storage media such as volatile and/or non-volatile storage components. For instance, the memory hardware 144 may be associated with one or more physical devices in communication with one another and may include optical, magnetic, organic, or other types of memory or storage. The memory hardware 144 is configured to, inter alia, to store instructions (e.g., computer-readable program instructions), that when executed by the controller 142, cause the controller 142 to perform numerous operations, such as, without limitation, altering the pose P of the robot 100 for maintaining balance, maneuvering the robot 100, detecting objects, transporting objects, and/or performing other tasks within the environment 10. In some implementations, the controller 142 performs the operations based on direct or indirect interactions with a sensor system 170.

The sensor system 170 includes one or more sensors 172, 172a-n. The sensors 172 may include vision/image sensors, inertial sensors (e.g., an inertial measurement unit (IMU)), and/or kinematic sensors. Some examples of image/vision sensors 172 include a camera such as a monocular camera or a stereo camera, a time of flight (TOF) depth sensor, a scanning light-detection and ranging (LIDAR) sensor, or a scanning laser-detection and ranging (LADAR) sensor. More generically, the sensors 172 may include one or more of force sensors, torque sensors, velocity sensors, acceleration sensors, position sensors (linear and/or rotational position sensors), motion sensors, location sensors, load sensors, temperature sensors, pressure sensors (e.g., for monitoring the end-effector actuator A_{EE}), touch sensors, depth sensors, ultrasonic range sensors, infrared sensors, and/or object sensors. In some examples, the sensor 172 has a corresponding field(s) of view defining a sensing range or region corresponding to the sensor 172. Each sensor 172 may be pivotable and/or rotatable such that the sensor 172 may, for example, change the field of view about one or more axis (e.g., an x-axis, a y-axis, or a z-axis in relation to a ground surface 12). In some implementations, the body 110 of the robot 100 includes a sensor system 170 with multiple sensors 172 about the body to gather sensor data 174 in all directions around the robot 100. Additionally or alternatively, sensors 172 of the sensor system 170 may be mounted on the arm 150 of the robot 100 (e.g., in conjunction with one or more sensors 172 mounted on the body 110). The robot 100 may include any number of sensors 172 as part of the sensor system 170 in order to generate sensor data 174 for the environment 10 about the robot 100. For instance, when the robot 100 is maneuvering about the environment 10, the sensor system 170 gathers pose data for the robot 100 that includes inertial measurement data (e.g., measured by an IMU). In some examples, the pose data includes kinematic data and/or orientation data about the robot 100.

When surveying a field of view with a sensor 172, the sensor system 170 generates sensor data 174 (also referred to as image data 174) corresponding to the field of view. Sensor data 174 gathered by the sensor system 170, such as the image data, pose data, inertial data, kinematic data, etc., relating to the environment 10 may be communicated to the control system 140 (e.g., the controller 142 and/or memory hardware 144) of the robot 100. In some examples, the sensor system 170 gathers and stores the sensor data 174 (e.g., in the memory hardware 144 or memory hardware related to remote resources communicating with the robot 100). In other examples, the sensor system 170 gathers the sensor data 174 in real-time and processes the sensor data 174 without storing raw (i.e., unprocessed) sensor data 174. In yet other examples, the controller system 140 and/or remote resources store both the processed sensor data 174 and raw sensor data 174. The sensor data 174 from the sensors 172 may allow systems of the robot 100 to detect and/or to analyze conditions about the robot 100. For instance, the sensor data 174 may allow the control system 140 to maneuver the robot 100, alter a pose P of the robot 100, and/or actuate various actuators A for moving/rotating mechanical components of the robot 100 (e.g., about joints J of the robot 100).

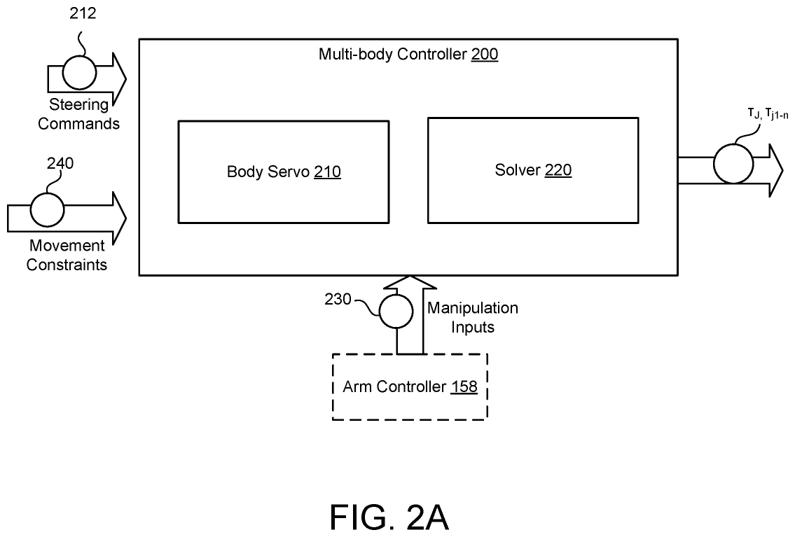

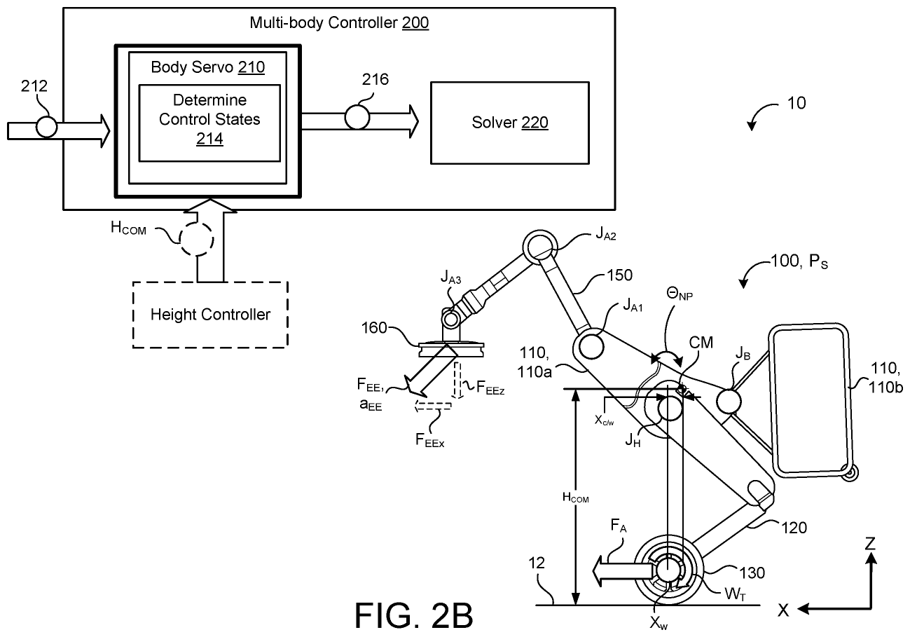

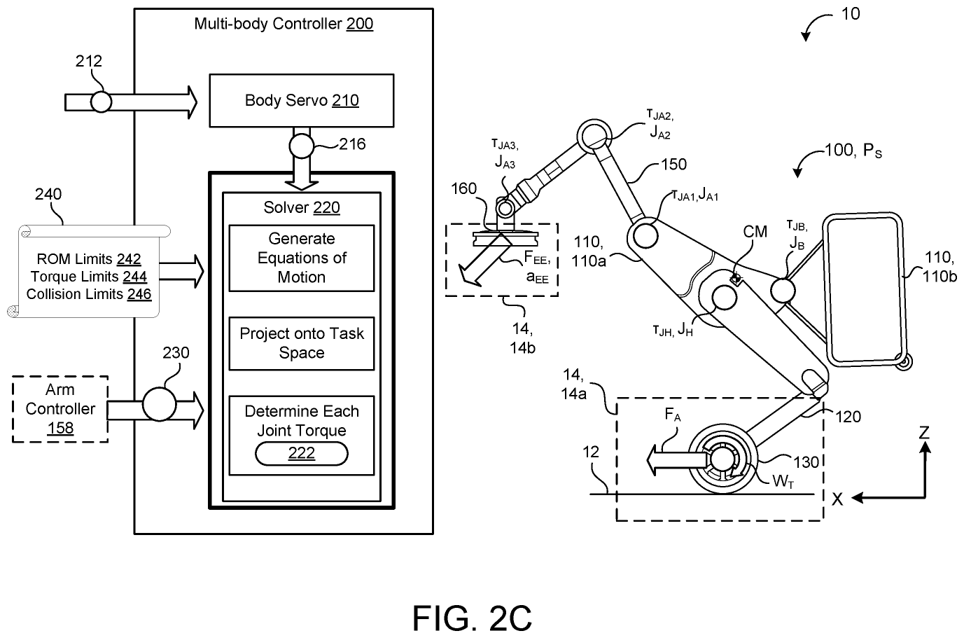

FIGS. 2A-2C are examples of the multi-body controller 200. The multi-body controller 200 generally includes a body servomechanism 210 (also referred to as a body servo) and a solver 220. The multi-body controller 200 is configured to receive inputs for a task and to generate a joint torque τ_{J} for a plurality of joints J of the robot 100 to perform the given task. Here, the task may include a balance objective and a manipulation objective. The inputs may include at least one of steering commands 212, manipulation inputs 230 for operation of the arm 150, or movement constraints 240. In some examples, the multi-body controller 200 identifies the balance objective and the manipulation objective. In other examples, the multi-body controller 200 receives inputs (e.g., the steering commands 212 and/or manipulation inputs 230 and/or the movement constraints 240) that indicate or correspond to the balance objective and the manipulation objective. The balance objective refers to generating a state of balance that enables the robot 100 to perform the task within the environment 10. For example, when the task is to lift a box 20 (e.g., shown in FIG. 1A) off a pallet 30 while the robot 100 is stationary (i.e., in a standing pose) and adjacent to the box 20, the balance objective is for the robot 100 to maintain balance as the arm 150 engages and lifts the box 20 without generating much motion at the drive wheels 130 to compromise the task (e.g., not causing a ground collision with the pallet 30 during balance for the task). As another example, when the task for the robot 100 is to lift the box 20 when the robot 100 is not adjacent to the pallet 30, this task may be executed in a few ways involving different balance objectives. In one approach, the robot 100 navigates to the pallet 30 that includes the box 20, stops adjacent to the pallet 30, and proceeds to lift the box 20. Here, the balance objective includes a component of balance during movement of the robot 100 to the pallet 30 (e.g., during a movement pose) and a component of balance from a standing pose while the robot 100 stops adjacent the pallet and lifts the box 20. In a second approach, the robot 100 may lift the box 20 while the robot 100 is moving or lift the box 20 simultaneous to the robot 100 stopping at the pallet 30 (e.g., attempting to minimize stationary time for the robot 100). For instance, the robot 100 moves forward towards the pallet 30 and immediately lifts the box 20 as the robot 100 reverses away from the pallet 30. Here, the balance objective includes a component for balanced motion of the robot 100 without the box 20 and component for balanced motion of the robot 100 with/during engagement of the box 20. The manipulation objective refers to generating a force or an acceleration for the arm 150 to execute the given task (e.g., with the end-effector 160). For instance, an acceleration that moves the arm 150 to a position to lift the box 20 and an actuation force that enables the end-effector 160 to lift the box 20.

In some examples, the multi-body controller 200 is part of the control system 140. In other examples, the multi-body controller 200 is independent from the control system 140, but communicates the joint torques τ_{J} to allow the control system 140 to implement the joint torques τ_{J} for the robot 100 (e.g., enables the control system 140 to actuate the actuators A to achieve the joint torques τⱼ). In some configurations, the multi-body controller 200 communicates with other controllers of the robot 100 to generate the joint torque τ_{J}. For instance, the multi-body controller 200 may receive manipulation inputs 230 regarding an operation of the arm 150 and/or end-effector 160. The operation of the arm 150 and/or end-effector 160 performs tasks requiring some means of manipulation (e.g., lifting a box 20). Here, manipulation generally refers to modifying a spatial relationship of an object. Some examples of manipulation include grasping, pushing, sliding, tipping, rolling, throwing, or other means of moving an object. To perform manipulation, the arm 150 (e.g., at the end-effector 160) may exert an end-effector force F_{EE} (FIGS. 2B and 2C) on the object according to kinematics of the arm 150. For instance, to perform a task requiring manipulation (i.e., a task with a manipulation objective), the end-effector 160 of the arm 150 exhibits an end-effector acceleration a_{EE}(FIGS. 2B and 2C) to impart the end-effector force F_{EE} on the object. In some examples, an arm controller 158 is configured to control the arm 150 with the end-effector 160 separate from the multi-body controller 200. In these examples, the arm controller 158 communicates the end-effector force F_{EE} and/or the end-effector acceleration a_{EE}, that the arm controller 158 generates to perform manipulation to the multi-body controller 200 as the manipulation inputs 230. The multi-body controller 200 may then use these manipulation inputs 230 to generate the joint torque τ_{J} for a given task. In some implementations, the arm controller 158 is a closed loop controller (e.g., a feed forward closed loop controller).

Referring to FIG. 2B, the body servo 210 is configured to receive steering commands 212 as inputs and to control states of the robot 100 based on the steering commands 212. The steering commands 212 may direct the robot 100 to move in a particular way or direction. For instance, the steering commands 212 specify a direction and/or velocity for the robot 100 to travel along. In some examples, the steering commands 212 are task-based where the steering commands 212 direct the robot 100 to move in order to perform a given task within the environment 10. The steering commands 212 may be received as an input from an operator of the robot 100, such as a user controlling the robot 100 remotely (e.g., with a joystick, buttons, or a remote device), or from an autonomous or a semi-autonomous system of the robot 100 (e.g., programmatically). Although, the body servo 210 receives steering commands 212, the body servo 210 is generally agnostic from a source of the steering commands 212.

The body servo 210 is configured to control dynamic states (referred to as control states 214) for the robot 100. In some examples, the control states 214 are dynamics for the robot 100 with respect to the sagittal plane P_{S} of the robot 100. Referring to FIGS. 1B and 2B, the sagittal plane P_{S} spans the X-Z plane of the reference coordinate system. In some implementations, the control states 214 of the robot 100 that the body servo 210 controls include a wheel position x_{w} of the robot 100 (i.e., wheel position x_{w} with respect to a fixed world frame), a COM relative to the wheel x_{c/w}, a natural pitch θₙₚ, and derivatives corresponding to these states (e.g., wheel velocity, wheel acceleration, velocity of COM, acceleration of COM, natural pitch angular velocity, natural pitch angular acceleration, etc.). Here, the natural pitch θₙₚ refers to a pitch-approximation for a robotic structure (i.e., the robot 100) with multiple inertial bodies. For example, instead of assuming the pitch of the robot 100 is solely based on a central body of the robot 100 (e.g., the torso 110 of the robot 100), the natural pitch θₙₚ accounts for other additional inertial bodies of the robot 100 (e.g., legs, arms, tail, or other appendages). In order to be a representative pitch approximation for an entirety of the robot 100, the natural pitch θₙₚ uses the sensor system 170 to determine joint angles for joints J of the robot 100 along with orientation(s) for components of the robot 100 (e.g., the body 110, the legs 120, the arm 150, etc.). With a state of the robot 100 captured by the joint angles and the orientation data derived from other sensor data 174 (e.g., kinematic data or IMU data), the control system 140 of the robot 100 estimates the natural pitch θₙₚ of the robot 100 that the body servo 210 is configured to control.

In some implementations, although a height H_{COM} of the COM of the robot 100 is a spatial relationship of the sagittal plane P_{S}, the body servo 210 is not responsible for the height H_{COM} of the COM of the robot 100. Instead, a height controller separate from the body servo 210 may determine the height H_{COM} of the robot 100. In some examples, the height controller is a proportional integral derivative (PID) controller with closed-loop control feedback. The height controller, as a PID controller, may be a feed forward PID controller. A feed forward controller is generally configured with predictive feedback to generate preemptive controls rather than merely reactive or responsive controls of a typical PID control loop. When the height H_{COM} of the robot 100 is determined by a separate controller (e.g., the height controller), the separate controller communicates the height H_{COM} of the robot 100 to the body servo 210. Here, even though the body servo 210 may not control the height H_{COM} of the robot 100, the body servo 210 may generate task-space control actions 216 such as a wheel torque τ_{W} or wheel axle force F_{A} based on the height H_{COM} of the robot 100. In other words, the height H_{COM} of the robot 100 is a measured state (e.g., similar to a control state 214) for the body servo 210.

With the dynamics of the robot 100, the body servo 210 is configured to generate task-space control actions 216. Here, to perform a task with a balance objective and a manipulation objective for a mobile robot 100 (e.g., with drive wheels 130), the control actions 216 are a wheel torque τ_{W} about the drive wheel 130 and an axle force F_{A} at the respective drive wheel 130. Since the control states 214 of the robot 100 are a result of the steering commands 212, the body servo 210 therefore generates the wheel torque τ_{W} and the axle force F_{A} based on the steering commands 212 or an influence of the steering commands 212. The body servo 210 is configured to communicate the wheel torque τ_{W} and the axle force F_{A} for the drive wheel 130 (i.e., the control actions 216) to the solver 220.

In some examples, the body servo 210 generates control actions 216 of wheel torque τ_{W} and the axle force F_{A} by using a physical linear system. The linear system may be generally represented by a state-space equation as follows:

\dot{x}=ax+bu (1)

where x is a vector that represents the control states 214 of the robot 100, \dot{x} is a vector that represents derivatives of the control states 214, and u is a vector that represents the control actions 216. As a relationship between a current state of the robot 100 and the future state of the robot 100, the linear system may also account for the impact of the arm 150 and/or end-effector 160. Since the arm controller 158 is separate from the body servo 210, the body servo 210 does not need to determine end-effector forces F_{EE}, but rather receives the end-effector forces F_{EE} as known values for the linear system. When the linear system represents the state-space for the X-Z plane (i.e., sagittal plane P_{S}), the end-effector forces F_{EE} may be represented as a force component in an x-direction, F_{EE}, F_{EE,x}, and a force component in the z-direction F_{EE}, F_{EE,z}. With this expression for the state-space, the body servo 210 determines the control actions 216. With control actions 216 corresponding to the wheel torque τ_{W} and the axle force F_{A} for a drive wheel 130, the body servo 210 may determine the wheel torque τ_{W} and the axle force F_{A} for each drive wheel 130 of the robot 100 separately or collectively. In some examples, depending on the task, the wheel torque τ_{W} and the axle force F_{A} may differ between the drive wheels 130.

To generate the control actions 216, the body servo 210 may be a controller that uses model predictive control (MPC) (i.e., a receding horizon controller). MPC is generally a finite-horizon optimization model that iteratively determines a current state of a system and a predicted state path. Additionally, MPC may control multivariables and use a history of previous system control to improve future states. Here, MPC may allow the body servo 210 to accurately predict and to generate the control actions 216 based on the current measured control states 214.

Referring to FIG. 2C, the solver 220 is configured to receive the control actions 216 from the body servo 210 and generate a joint torque τ_{J} for each of the joints J of the robot 100. Here, the joint torque τ_{J} generates an angular momentum effect on the robot 100 to control the robot 100 during performance of a task. In some examples, the multi-body controller 220 uses the joint torques τ_{J} to generate a manipulation force and applies the manipulation force at the end-effector 160 of the robot 100. Here, the manipulation force may supplement or augment the control of the robot 100 using the joint torques τ_{J} generated for the plurality of joints J.

The solver 220 may be configured to generate joint torques τ_{J} for any number n of joints J. For instance, although FIGS. 1A-2C depict the robot with five joints J, J_{A1}, J_{A2}, J_{A3}, J_{B}, J_{H}, the robot 100 may have more or less joints J depending on a design of the robot 100. Generally, the solver 220 seeks to optimize the joint torques τ_{J} based on the inputs that the solver 220 receives for a given task. Due to this optimization, the solver 220 may determine that a joint torque τ_{J} for a joint J may range from zero (i.e., no torque) to predominately contributing to the balance objective and the manipulation objective. In other words, at an extreme, a single joint J may counteract forces experienced by the robot 100 during manipulation. However, with multiple joints J and inputs, such as the movement constraints 240, it is unlikely that the solver 220 makes a single joint J counteract the forces of the robot 100 during a task. In fact, when optimization by the solver 220 achieves a cost function (e.g., minimizes), it is more likely that a single joint J is not the predominant contributor to the collective joint torque τ_{J}. In the example illustrated by FIG. 2C, the solver 220 generates a joint torque τ_{J}, τ_{JB}, τ_{JH}, τ_{JA1}, τ_{JA2}, τ_{JA3}, for each of the five joints J, J_{B}, J_{H}, J_{A1}, J_{A2}, J_{A3}.

The solver 220 is configured to receive as inputs the control actions 216 from the body servo 210, the impacts of the end-effector (e.g., end-effector forces F_{EE}), and movement constraints 240 of the robot 100. The movement constraints 240 of the robot 100 may refer to physical limitations of the robot 100 or spatial limitations of the robot 100 (e.g., limitations within the environment 10). Some examples of physical limitations of the robot 100 include range of motion limitations 242 and torque limitations 244, while examples of spatial limitations of the robot 100 include collision limitations 246. These movement constraints 240 may be dynamic, static, or some combination of both. Here, a dynamic movement constraint 240 is a constraint that may change over time or with movement of the robot 100 within the environment 10. A static movement constraint 240 refers to a constant movement constraint 240 that is known about the robot 100 and/or about the environment 10.

A range of motion limitation 242 refers to a measured amount of movement about a joint J. The range of motion about a joint J may be limited by the capabilities of the joint itself or limited to prevent overlapping ranges of motion between joints J. To illustrate a limitation of the range of motion for a joint itself, the joint J may have a structure that defines the range of motion. For example, the mechanical coupling for joints J such as rotational joints, orthogonal joints, revolving joints, linear joints, twisting joints, etc., limits the range of motion for the joint J (e.g., a static range of motion limitation 242). Additionally or alternatively, there may be situations where, although a joint J is capable of a larger range of motion (e.g., a full range of motion), an operator of the robot 100 or a system of the robot 100 decides that a particular task or mode should further limit the range of motion for the joint J (e.g., as a dynamic range of motion limitation 242). For instance, the robot 100 may have a travel mode where the robot 100 performs limited types of tasks where at least one joint J has a reduced range of motion when compared to a full range of motion for the joint J (e.g., in other modes). In some examples, the range of motion limitation 242 refers to a portion of the full range of motion for a joint J that is restricted during particular types of tasks. For example, when the end-effector 160 lifts a box 20, the second arm joint J_{A2} may not be fully extended. Here, fully extending the second arm joint J_{A2} may detrimentally impact the torque τ at the end-effector 150 such that the solver 220 (or other system of the robot 100) designates this portion of the range of motion as a range of motion limitation 242.

As an example of overlapping ranges of motion, referring to FIG. 2C, there may be risk that the arm 150 may move about the first arm joint J_{A1} (i.e., the shoulder joint J) and interfere (e.g., collide) with the CBB 110b that moves about the back joint J_{B}. Due to these types of potential interference, a range of motion limitation 242 may be designated for either the back joint J_{B} or the first arm joint J_{A1} or both joints J. In other words, range of motion limitations 242 may prevent inter-body collisions (e.g., as a static range of motion limitation 242).

Torque limitations 244 refer to constraints related to an amount of torque τ that may be generated at a particular joint J. Torque limitations 244 are typically physical limitations because an actuator A associated with a particular joint J may only be able to produce a maximum amount of torque τ about the joint J. In some examples, an actuator A associated with a particular joint J is rated for a maximum torque based on properties, such as size, geometry, material composition, fluid dynamics, etc. These ratings therefore translate to a torque limitation 244 for a given joint J associated with one or more actuators A.

Collision limitations 246 refer to limitations imposed on the robot 100 to avoid collisions between a portion of the robot 100 and the environment 10. Here, some collision limitations 246 may be static while other collision limitations 246 are dynamic. For instance, some static collision limitations 246 exist when the robot 100 is in an environment 10 (e.g., confined to a particular environment 10) that has permanent features that the robot 100 must avoid (e.g., walls, flooring, shelving, cabinets, stationary machinery, support structures, etc.). Some other collision limitations 246 are dynamic in that unknown objects or risks of collisions for the robot 100 may be introduced to the robot 100 during operation.

In some examples, the solver 220 is pre-programmed with the movement constraints 240. For example, an algorithm of the solver 220 accounts for the movement constraints 240. In other examples, the solver 220 is programmed with some movement constraints 240, such as the range of motion limitations 242 and/or the torque limitations 244, while other movement constraints 240 (e.g., dynamic movement constraints 240 such as collision limitations 246) are received by the solver 220 prior to generating the joint torques τ_{J}. For instance, systems of the robot 100 may generate dynamic movement constraints 240 (e.g., collision limitations 246) as the robot 100 maneuvers about the environment 10. This may allow the sensor system 170 to detect potential collisions during operation of the robot 100. For example, when tasked to move the box 20, the robot 100 may not be aware of the pallet 30 protruding on the ground surface 12 before the box 20 until the robot 100 is within sensing range of the pallet 30. Here, the robot 100 may generate the collision limitations 246 based on the sensor data 174 and the kinematics of the robot 100 and communicate the collision limitation 246 to the solver 220.

The solver 220 is configured to generate the joint torque τ_{J} for each of the plurality of joints J₁₋ₙ by satisfying the movement constraints 240 based on the manipulation inputs 230, the wheel torque τ_{W}, and the axle force F_{A}. In some examples, as shown in FIG. 2C, to generate the joint torques τ_{J}, the solver 220 generates equations of motion, projects the equations of motion onto a task space 14, and determines each joint torque τ_{J} for the joints J according to a joint torque algorithm 222. In some examples, the solver 220 is an inverse dynamics solver that generates the equations of motion for the robot 100. In some implementations, the solver 220 generates equations of motion that are represented as follows:

M\ddot{q}+C(q,\dot{q})+C_{gravity}(q)=Dτ+Jₐₓₗₑ^{T}Fₐₓₗₑ+Jₑₑ^{T}Fₑₑ (2)

where q, \dot{q}, \ddot{q} are vectors representing joint angles, joint angular velocities, and joint angular accelerations, M is a mass matrix for the system, C is a vector representing Coriolis and centrifugal forces, C_{gravity} is a vector representing gravitational forces, D is a torque matrix for the system, τ is a vector representing the joint torques, the term Jₐₓₗₑ^{T}Fₐₓₗₑ represents an external effect about the drive wheel 130, and the term Jₑₑ^{T}Fₑₑ represents an external effect of the end-effector 160 of the arm 150. In some configurations, the q term additionally accounts for the pitch θ of the robot 100 (e.g., the natural pitch θ_{P}). Here, equation (2) represents a more general equation of motion that includes the motion about the drive wheel 130 and the motion about the end-effector 150. With regard to equation (2), the external effects of the drive wheel 130 and of the end-effector 160 are known since the solver 220 receives the controls action 214 corresponding to the external effects of the drive wheel 130 from the body servo 210 and the manipulation inputs 230 corresponding to the external effects of the end-effector 160 from the arm controller 158. Accordingly, the solver 220 may isolate the term Dτ representing all of the joint torques τ_{J} in light of all the remaining known variables.

In order to determine all of the joint torques τ_{J}, the solver 220 is configured to account for the limitations for the robot 100 during the task as represented by the movement constraints 240. In some examples, the solver 220 generates the joint torques τ_{J} using the joint torque algorithm 222. In some implementations, the joint torque algorithm 222 is an optimization cost function. The solver 220 uses the optimization cost function to achieve the balance objective for a task while also achieving the manipulation objective for the task. In some examples, the solver 220 minimizes the optimization cost function to minimize the balance objective and to minimize the manipulation objective. In some configurations, the optimization cost function is a quadratic function where the solver 220 uses quadratic programming to determine the joint torques τ_{J} based on the movement constraints 240 as linear constraints. In other words, the solver 220 may be a quadratic programming solver that determines an optimal solution for the joint torques τ_{J} to control the robot 100 while the robot 100 performs the task. In some configurations, the joint torque algorithm 222 is represented by the following quadratic optimization function:

$${min}_{τ} {‖ {A}_{1} τ - {b}_{1} ‖}^{2} {w}_{1} + {‖ {A}_{2} τ - {b}_{2} ‖}^{2} {w}_{2} + α ‖ τ - {τ}_{d} ‖ w \qquad ( 3 )$$

where the term ∥A₁τ−b₁∥² represents the balance objective, the term ∥A₂τ−b₂∥² represents the manipulation objective, and the term α∥τ−τ_{d}∥ represents a null servo. In other words, equation (3) expresses the objectives as functions of torque τ.

When the solver 220 solves equation (2) for the term DT, the solver 220 projects the solution into the task-space 14 for the robot 100. The task-space 14 refers to specific portions of the environment 10 of the robot 100. Here, with a mobile robot 100 using rolling motion and including the arm 150 with the end-effector 160, the task-space 14 refers to two spaces 14, 14a-b. A first space 14, 14a about the drive wheel 130 of the robot 100 and the second space 14, 14b about the end-effector 160 of the arm 150. With the task-space 14a about the drive wheel 130, the task-space 14a is oriented such that during rolling ground contact, the center (i.e., axis) of the drive wheel 130 is not moving in the z-direction with respect to the ground surface 12 while the center of the drive wheel 130 is moving according to the rolling contact in the horizontal direction (i.e., x-direction). By projecting the term DTτ into the task-space 14, the solver 220 generates a term of A₁τ−b₁ for the first task 14a space relating to the balance objective and a term of A₂τ−b₂ for the second task 14b space relating to the manipulation objective. In some examples, the joint torque algorithm 222 includes a first weight w₁ to the balance objective and a second weight w₂ to the manipulation objective. Here, the weights w_{1,2} may be applied by the solver 220 to indicate an objective importance for the task. In other words, the solver 220 may recognize when a task requires more balance than manipulation (or vice versa) and weighs the terms corresponding to these objectives accordingly.

In some examples, the task-space 14 includes a subspace known as the null space. In the null space, there may be a redundancy of solutions for the objectives (i.e., the balance objective and the manipulation objective) of the joint torque algorithm 222. The null space is configured to limit an output for variables of the joint torque algorithm 222 that are resolvable by limiting the robot 100 to the null space. In other words, the solver 220 may encounter an issue where an objective loses rank causing the objective to be indeterminate. For example, the solver 220 determines that an objective is infinite. When the solver 220 determines the balance objective or the manipulation objective is indeterminate, the joint torque algorithm 222 includes the null servo as a term that defines a default torque τ_{d}. Here, the default torque τ_{d} corresponds to joint torques τ_{J} for the plurality of joints J without compromising the objectives for the solver 220 to maintain some desired joint configuration or poses of the robot 100. In some implementations, the default torque τ_{d} is a vector representing each of the joints J. The default torque τ_{d} may therefore be configured to apply to any combination of one or more joints J depending on the objectives for the robot 100. In some examples, the default torque τ_{d} is generated by a secondary controller. The secondary controller may be configured to operate in the null space of a primary controller, such as the multi-body controller 200. In some examples, the secondary controller is a proportional derivative (PD) servo loop to control the robot 100 in the null space.

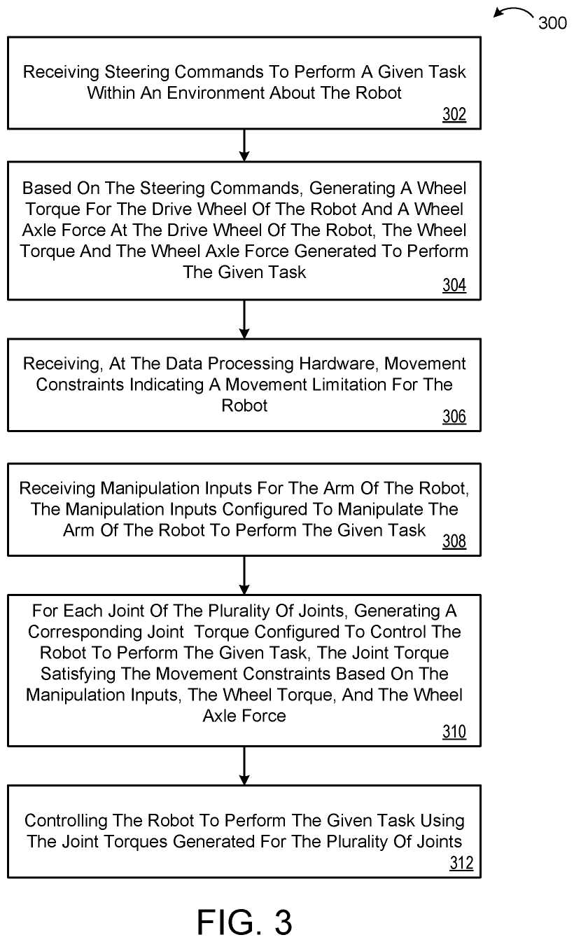

FIG. 3 is a method 300 of using the multi-body controller 200. At operation 302, the method 300 receives steering commands 212 to perform a given task within an environment 10 about the robot 100. Here, the robot 100 includes an inverted pendulum body 110 having a first end portion 112, a second end portion 114, a plurality of joints J, J₁₋ₙ, and an arm 150 coupled to the inverted pendulum body 110 at a first joint J₁ of the plurality of joints J. The robot 100 also includes at least one leg 120 having first and second ends 122, 124 where the first end 122 is coupled to the inverted pendulum body 110 at a second joint J₂ of the plurality of joints J₁₋ₙ, and a drive wheel 130 rotatably coupled to the second end 124 of the at least one leg 120. Based on the steering commands 212, at operation 304, the method 300 generates a wheel torque τ_{W} for the drive wheel 130 of the robot 100 and a wheel axle force F_{A} at the drive wheel 130 of the robot 100. Here, the wheel torque τ_{W} and the wheel axle force F_{A} are generated to perform the given task. At operation 306, the method 300 receives movement constraints 240 indicating movement limitations for the robot 100. At operation 308, the method 300 receives manipulation inputs 230 for the arm 150 of the robot 100. The manipulation inputs 230 are configured to manipulate the arm 150 of the robot 100 to perform the given task. For each joint J of the plurality of joints J₁₋ₙ, at operation 310, the method 300 generates a corresponding joint torque τ_{J} configured to control the robot 100 to perform the given task. To generate the corresponding joint torque τ_{J}, the joint torque satisfies the movement constraints 240 based on the manipulation inputs 230, the wheel torque τw, and the wheel axle force F_{A}. At operation 312, the method 300 controls the robot 100 to perform the given task using the joint torques τ_{J} generated for the plurality of joints J₁₋ₙ.

Optionally the method 300 may include the following aspects. In some implementations, generating the corresponding joint torque τ_{J} for each of the plurality of joints J₁₋ₙ includes using a joint torque algorithm 222 to minimize a balance objective, to balance the robot 100, and to minimize a manipulation objective, to move the arm 150 of the robot 100 based on the given task where the joint torque algorithm 222 includes a quadratic function based on the received movement constraints 240. In some examples, when the balance objective or the manipulation objective is indeterminate while using the joint torque algorithm 222 to minimize the balance objective and to minimize the manipulation objective, the joint torque algorithm 222 applies a default torque τ_{d} to control the robot 100 to perform the given task without compromising the balance objective and the manipulation objective. In some configurations, using the joint torque algorithm 222 to minimize the balance objective and to minimize the manipulation objective includes applying a first weight w₁ to the balance objective and applying a second weight w₂ to the manipulation objective where the first weight w₁ and the second weight w₂ indicate an objective importance for the given task.

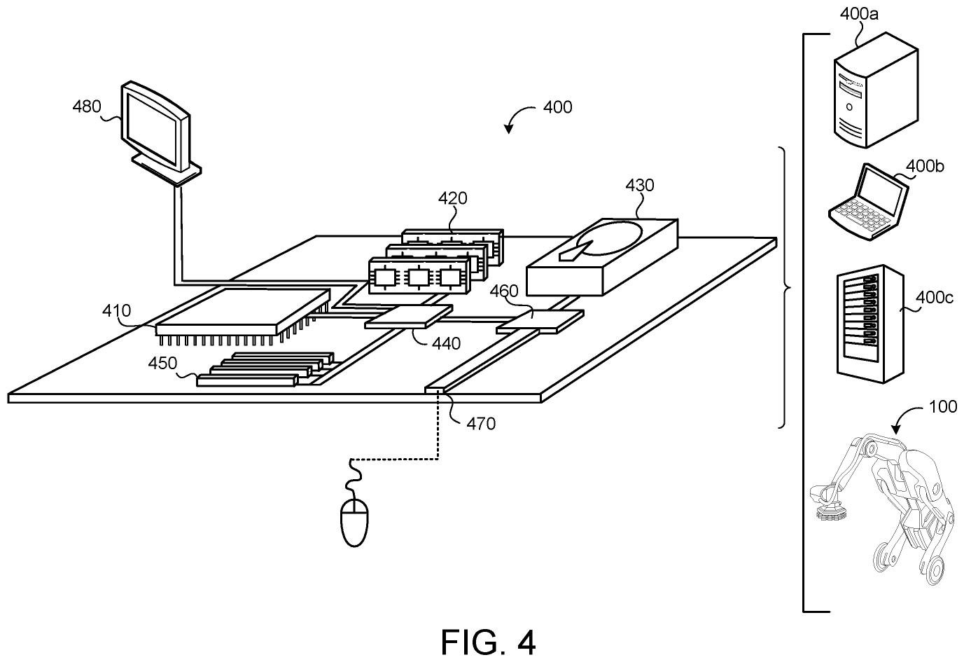

FIG. 4 is schematic view of an example computing device 400 that may be used to implement the systems (e.g., the control system 140, the sensor system 170, the arm controller 158, the multi-body controller 200, the null servo, etc.) and methods (e.g.,, the method 300) described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware of a robot, steering commands to perform a given task within an environment about the robot, the robot comprising:
an inverted pendulum body having a first end portion, a second end portion, and a plurality of joints;
an arm coupled to the inverted pendulum body at a first joint of the plurality of joints, the arm comprising an end-effector configured to grasp an object;
at least one leg having first and second ends, the first end coupled to the inverted pendulum body at a second joint of the plurality of joints; and
a drive wheel rotatably coupled to the second end of the at least one leg;
based on the received steering commands, generating, by the data processing hardware, a wheel torque for the drive wheel of the robot and a wheel axle force at the drive wheel of the robot, the wheel torque and the wheel axle force generated to perform the given task;
receiving, at the data processing hardware, movement constraints for the robot;
receiving, at the data processing hardware, one or more manipulation inputs for the end-effector of the arm of the robot, the one or more manipulation inputs configured to manipulate the arm of the robot to perform the given task; and
for each joint of the plurality of joints, generating, by the data processing hardware, a corresponding joint torque configured to control the robot to perform the given task, the joint torque satisfying the movement constraints based on the one or more manipulation inputs, the wheel torque, and the wheel axle force; and
controlling, by the data processing hardware, the robot to perform the given task using the joint torques generated for the plurality of joints.

2. The method of claim 1, wherein generating the corresponding joint torque for each of the plurality of joints comprises using a joint torque algorithm to achieve a balance objective of the robot and to achieve a manipulation objective for moving the arm of the robot based on the given task, the joint torque algorithm comprising a quadratic function based on the received movement constraints.

3. The method of claim 2, wherein, when the balance objective or the manipulation objective is indeterminate while using the joint torque algorithm to achieve the balance objective and to achieve the manipulation objective, the joint torque algorithm applies a default torque to the corresponding joint of the plurality of joints to control the robot to perform the given task without compromising the balance objective and the manipulation objective.

4. The method of claim 2, wherein using the joint torque algorithm to achieve the balance objective and to achieve the manipulation objective comprises:
applying a first weight to the balance objective; and
applying a second weight to the manipulation objective, the first weight and the second weight indicating an objective importance for the given task.

5. The method of claim 1, wherein the movement constraints comprise at least one of:
range of motion limitations for each of the plurality of joints;
torque limitations for each of the plurality of joints; or
collision limitations configured to avoid collisions for a portion of the robot.

6. The method of claim 1, wherein the first end of the at least one leg is coupled to the second end portion of the inverted pendulum body.

7. The method of claim 1, wherein the robot further comprises a counter-balance body disposed on the inverted pendulum body and configured to move relative to the inverted pendulum body.

8. The method of claim 7, wherein the counter-balance body is disposed on the first end portion of the inverted pendulum body.

9. The method of claim 7, wherein the counter-balance body is disposed on the second end portion of the inverted pendulum body.

10. The method of claim 7, wherein the plurality of joints of the inverted pendulum body comprises:
the first joint coupling the arm to the inverted pendulum body;
the second joint coupling the first end of the at least one leg to the inverted pendulum body;
a third joint coupling the inverted pendulum body to the counter-balance body; and
at least one arm joint coupling two members of the arm together.

11. The method of claim 10, wherein the arm comprises:
a first member having a first end and a second end, the first end of the first member coupled to the first end portion of the inverted pendulum body at the first joint;
a second member having a first end and a second end, the first end of the second member coupled to the second end of the first member at a first arm joint of the at least one arm joint; and
a third member having a first end and a second end, the first end of the third member coupled to the second end of the second member at a second arm joint of the at least one arm joint.

12. The method of claim 7, wherein the at least one leg comprises:
a right leg having first and second ends, the first end of the right leg prismatically coupled to the second end portion of the inverted pendulum body, the right leg having a right drive wheel rotatably coupled to the second end of the right leg; and
a left leg having first and second ends, the first end of the left leg prismatically coupled to the second end portion of the inverted pendulum body, the left leg having a left drive wheel rotatably coupled to the second end of the left leg.

13. The method of claim 1, wherein the manipulation inputs correspond to a force or an acceleration for the end-effector.

14. The method of claim 1, wherein controlling the robot to perform the given task using the joint torques generated for the plurality of joints comprises:
generating a manipulation force based on the joint torques generated for the plurality of joints; and
applying the manipulation force at the end-effector of the robot.

15. A robot comprising:
an inverted pendulum body having a first end portion, a second end portion, and a plurality of joints;
an arm coupled to the inverted pendulum body at a first joint of the plurality of joints, the arm comprising an end-effector configured to grasp an object;
at least one leg having first and second ends, the first end coupled to the inverted pendulum body at a second joint of the plurality of joints;
a drive wheel rotatably coupled to the second end of the at least one leg;
data processing hardware; and
memory hardware in communication with the data processing hardware, the memory hardware storing instructions that when executed on the data processing hardware cause the data processing hardware to perform operations comprising:
receiving steering commands to perform a given task within an environment about the robot;
based on the received steering commands, generating a wheel torque for the drive wheel of the robot and a wheel axle force at the drive wheel of the robot, the wheel torque and the wheel axle force generated to perform the given task;
receiving movement constraints indicating movement limitations for the robot;
receiving manipulation inputs for the end-effector of the arm of the robot, the manipulation inputs configured to manipulate the arm of the robot to perform the given task; and
for each joint of the plurality of joints, generating a corresponding joint torque configured to control the robot to perform the given task, the joint torque satisfying the movement constraints based on the manipulation inputs, the wheel torque, and the wheel axle force; and
controlling the robot to perform the given task using the joint torques generated for the plurality of joints.

16. The robot of claim 15, wherein generating the corresponding joint torque for each of the plurality of joints comprises using a joint torque algorithm to achieve a balance objective to balance the robot and to achieve a manipulation objective to move the arm of the robot based on the given task, the joint torque algorithm comprising a quadratic function based on the received movement constraints.

17. The robot of claim 16, wherein, when the balance objective or the manipulation objective is indeterminate while using the joint torque algorithm to achieve the balance objective and to achieve the manipulation objective, the joint torque algorithm applies a default torque to the corresponding joint of the plurality of joints to control the robot to perform the given task without compromising the balance objective and the manipulation objective.

18. The robot of claim 16, wherein using the joint torque algorithm to achieve the balance objective and to achieve the manipulation objective comprises:
applying a first weight to the balance objective; and
applying a second weight to the manipulation objective, the first weight and the second weight indicating a torque importance for the given task.

19. The robot of claim 15, wherein the movement constraints comprise at least one of:
range of motion limitations for each of the plurality of joints;
torque limitations for each of the plurality of joints; or
collision limitations configured to avoid collisions for a portion of the robot.

20. The robot of claim 15, wherein the first end of the at least one leg is coupled to the second end portion of the inverted pendulum body.

21. The robot of claim 15, wherein the robot further comprises a counter-balance body disposed on the inverted pendulum body and configured to move relative to the inverted pendulum body.

22. The robot of claim 21, wherein the counter-balance body is disposed on the first end portion of the inverted pendulum body.

23. The robot of claim 21, wherein the counter-balance body is disposed on the second end portion of the inverted pendulum body.

24. The robot of claim 21, wherein the plurality of joints of the inverted pendulum body comprises:
the first joint coupling the arm to the inverted pendulum body;
the second joint coupling the first end of the at least one leg to the inverted pendulum body;
a third joint coupling the inverted pendulum body to the counter-balance body; and
at least one arm joint coupling two members of the arm together.

25. The robot of claim 24, wherein the arm comprises:
a first member having a first end and a second end, the first end of the first member coupled to the first end portion of the inverted pendulum body at the first joint;
a second member having a first end and a second end, the first end of the second member coupled to the second end of the first member at a first arm joint of the at least one arm joint; and
a third member having a first end and a second end, the first end of the third member coupled to the second end of the second member at a second arm joint of the at least one arm joint.

26. The robot of claim 21, wherein the at least one leg comprises:
a right leg having first and second ends, the first end of the right leg prismatically coupled to the second end portion of the inverted pendulum body, the right leg having a right drive wheel rotatably coupled to the second end of the right leg; and
a left leg having first and second ends, the first end of the left leg prismatically coupled to the second end portion of the inverted pendulum body, the left leg having a left drive wheel rotatably coupled to the second end of the left leg.

27. The robot of claim 15, wherein the manipulation inputs correspond to a force or an acceleration for the end-effector.

28. The robot of claim 15, wherein controlling the robot to perform the given task using the joint torques generated for the plurality of joints comprises:
generating a manipulation force based on the joint torques generated for the plurality of joints; and
applying the manipulation force at the end-effector of the robot.
